(19) United States
(12) Patent Application Publication
(10) Pub. No.: US 2026/0160226 A1
(43) Pub. Date: Jun. 11, 2026

(54) SYSTEMS, APPARATUSES, AND METHODS FOR ASSEMBLING FUEL SYSTEM COMPONENTS

(71) Applicant: Cummins Inc., Columbus, IN (US)

(72) Inventors: Stephanie Marie Detweiler, Jamestown, PA (US); Chuan Wang, Columbus, IN (US); Satya Dinakar Vyseetty, Bargersville, IN (US); Jordan D. Oakes, Columbus, IN (US); John D. King, Columbus, IN (US); Prithvi Prasad Tirumalai Vinjamore, Columbus, IN (US); Echo Graham Drachen, Lafayette, IN (US)

(21) Appl. No.: 19/404,725

(22) Filed: Dec. 1, 2025

Related U.S. Application Data
(60) Provisional application No. 63/729,574, filed on Dec. 9, 2024.

(51) Int. Cl. F02M 55/00; F02M 55/02

(52) U.S. Cl. CPC F02M 55/004; F02M 55/02

(57) ABSTRACT

Systems, apparatuses, and methods are provided for assembling a fuel system connector to a fuel system component. A retainer is used to maintain a fastener of the fuel system connector in position along a connector body of the fuel system connector. An end form on the end of the connector body is thereby maintained within the fastener as the fuel system connector is engaged to the fuel system component, protecting the end form from potential damage during assembly.

### CROSS-REFERENCE TO RELATED APPLICATION:

The present application claims priority to, and the benefit of the filing date of, U.S. Provisional Application Ser. No. 63/729,574 filed on Dec. 9, 2024, which is incorporated herein by reference.

### TECHNICAL FIELD OF THE DISCLOSURE:

The present application relates generally to fuel systems, and more particularly to systems, apparatuses, and methods for assembling fuel system components.

### BACKGROUND

Fuel systems include various components that are required to be assembled in order to place the fuel system in working condition. For example, fuel lines must be connected to a fuel source, such as a fuel rail, and to a fuel injector. The locations and/or configurations of fuel system components can cause difficulties in assembling connectors that couple these components to one another, including increased assembly time, potential for mis-assembly, and potential for damage to the fuel system components during assembly. Thus, there remains a need for further improvements in this area.

### DISCLOSURE OF ILLUSTRATIVE EMBODIMENTS

For the purposes of clearly, concisely and exactly describing illustrative embodiments of the present disclosure, the manner, and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created and that the invention includes and protects such alterations, modifications, and further applications of the exemplary embodiments as would occur to one skilled in the art.

### SUMMARY

Exemplary embodiments include systems, apparatuses, and methods for assembling fuel system components and/or for assembling a fuel system connector to a fuel system component. Exemplary embodiments include systems, apparatuses, and methods that are also provided for assembling a connector to a component.

For example, in an embodiment the system includes fuel system connector that connects a first fuel system component and a second fuel system component to one another. The fuel system connector includes a connector body configured to extend from the first fuel system component toward the second fuel system component. The connector body includes a first end having an end form for connection to the first fuel system component. The fuel system connector also includes a fastener positioned around and movable along the connector body toward and away from the first end of the connector body. The fastener is engageable to the first fuel system component to secure the end form in connection with the first fuel system component. The system also includes a retainer removably mounted to the connector body in contact with the fastener. The retainer secures the fastener in a position along the connector body so that the end form is located within the fastener as the fastener is positioned on the first fuel system component.

In another example, an apparatus for assembling a connector to a component is provided. The apparatus includes a spacer extending between a first end and an opposite second end. A first end member is located at the first end and a second end member is located at the second end. The first end member is configured to contact a fastener of the connector, and the second end member is configured to contact the connector body. A channel extends along the spacer, the first end member, and the second end member. The channel is configured to receive the connector body of the connector to secure the retainer apparatus thereto to retain the fastener in a position along the connector body.

In another example, an embodiment includes a method for assembling a fuel system connector to a fuel system component. The method includes inserting a fastener of the fuel system connector into the fuel system component while maintaining a position of the fastener along a connector body of the fuel system connector with a retainer removably mounted to the connector body in contact with the fastener so that an end form on an end of the connector body remains located within the fastener; provisionally engaging the fastener to the fuel system component while the retainer is mounted to the connector body to maintain the end form of the connector body within the fastener; removing the retainer from the connector body after provisionally engaging the fastener to the fuel system component; and finally engaging the fastener to the fuel system component so that the end form engages the fuel system component.

Further embodiments, forms, objects, features, advantages, aspects, and benefits shall become apparent from the following description and drawings.

### BRIEF DESCRIPTION OF THE DRAWINGS

FIG. 1 is a schematic illustration of fuel system and a retainer apparatus for facilitating the assembly of components of the fuel system.

FIG. 2 is a schematic sectional view showing a fuel system connector and fuel system component of the fuel system of FIG. 1.

FIG. 3 is a perspective view showing a portion of the fuel system connector with an embodiment of the retainer apparatus mounted on the fuel system connector.

FIG. 4 is a perspective view of the retainer apparatus of FIG. 3.

FIG. 5A is a perspective view of another embodiment retainer apparatus.

FIG. 5B is a perspective view showing a portion of the fuel system connector with the embodiment of the retainer apparatus of FIG. 5A mounted on the fuel system connector.

FIG. 6 is a perspective view of another embodiment retainer apparatus.

FIG. 7 is a perspective view of another embodiment retainer apparatus.

FIG. 8 is another perspective view of the retainer apparatus of FIG. 7.

FIG. 9 is a flow diagram of a method for assembling fuel system components using the retainer apparatuses disclosed herein.

### DETAILED DESCRIPTION OF ILLUSTRATIVE EMBODIMENTS

The systems, apparatuses, and methods disclosed herein include arrangements in which a fastener of a fuel system connector is maintained in a position during assembly of the fuel system components so that an end form of the fuel system connector remains within the fastener during the assembly. The systems, apparatuses, and methods disclosed herein include arrangements in which a fastener of a connector is maintained in a position during assembly to a component so that an end form of connector remains within the fastener during the assembly. This protects the fitting from damage during installation since the fastener rather than the end form of the connector body will first contact the component to which the connector is being fastened.

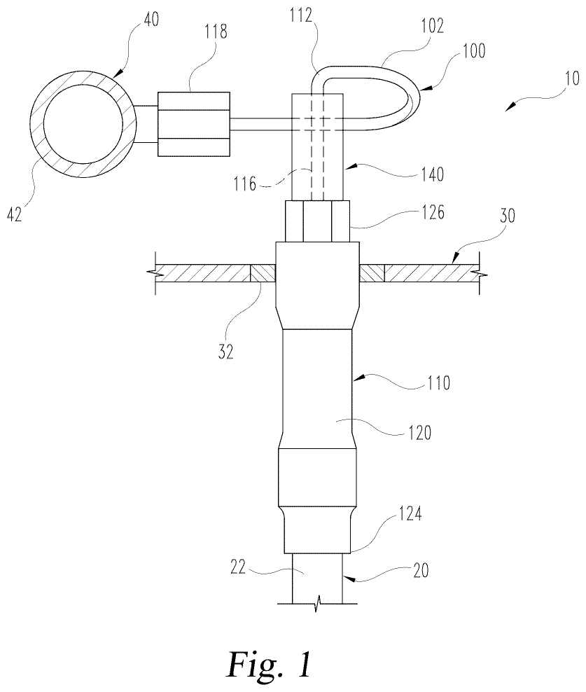

With reference to FIGS. 1-8, an embodiment of the present disclosure includes a system 10 includes fuel system connector 100 that connects a first fuel system component 20 and a second fuel system component 40 to one another. Fuel system connector 100 includes a connector body 102 configured to extend from first fuel system component 20 toward second fuel system component 40. Connector body 102 includes a first end 104 having an end form 106 for connection to first fuel system component 20. Fuel system connector 100 also includes a fastener 110 positioned around and movable along connector body 102 toward and away from first end 104 of connector body 102. Fastener 110 is engageable to first fuel system component 20 to secure end form 106 in connection with first fuel system component 102. System 10 also includes a retainer 150, 250, 350, 450 removably mounted to connector body 102 in contact with fastener 110. Retainer 150, 250, 350 450 secures fastener 110 in a position along connector body 102 so that end form 106 is located within fastener 110 as fastener 110 is positioned on first fuel system component 20.

In an embodiment, an apparatus 140 for assembling connector 100 to component 20 is provided. Apparatus 140 includes a spacer 152, 252, 352, 452 extending between a first end 154, 254, 354, 454 and an opposite second end 156, 256, 356, 456. A first end member 160, 260, 360, 460 is located at the first end 154, 254, 354, 454 and a second end member 162, 262, 363, 462 is located at the second end 156, 256, 356, 456. First end member 160, 260, 360, 460 is configured to contact fastener 110 of connector 100, and second end member 162, 262, 362, 462 is configured to contact connector body 102. A channel 158, 258, 358, 458 extends along spacer 152, 252, 353, 452, first end member 160, 260, 360, 460, and second end member 162, 262, 362, 462. Channel 158, 258, 358, 458 is configured to receive connector body 102 of connector 100 so apparatus 140 retains fastener 110 in a position along connector body 102.

In another example, an embodiment includes a method 800 for assembling fuel system connector 100 to fuel system component 20. Method 800 includes a step 802 of inserting fastener 110 of fuel system connector 100 into fuel system component 20 while maintaining a position of fastener 110 along connector body 102 of fuel system connector 100 with retainer 150, 250, 350, 450 removably mounted to connector body 102 in contact with fastener 110 so that end form 106 on end 104 of connector body 102 remains located within fastener 110; a step 804 of provisionally engaging fastener 110 to fuel system component 20 while retainer 150, 250, 350, 450 is mounted to connector body 102 to maintain end form 106 within fastener 110; a step 806 of removing retainer 150, 250, 350, 450 from connector body 102 after provisionally engaging fastener 110 to fuel system component 20; and a step 808 of finally engaging fastener 110 to fuel system component 20 so that end form 106 engages fuel system component 20.

Referring to FIG. 1, there is shown a schematic of an embodiment of fuel system 10. Fuel system 10 may include, for example, first fuel system component 20 and second fuel system component 40. Fuel system connector 100 is provided to connect first fuel system component 20 to second fuel system component 40. In an embodiment, first fuel system component is a fuel injector 22, second fuel system component 40 is a fuel rail 42, and fuel system connector 100 includes connector body 102 in the form of an injector tube.

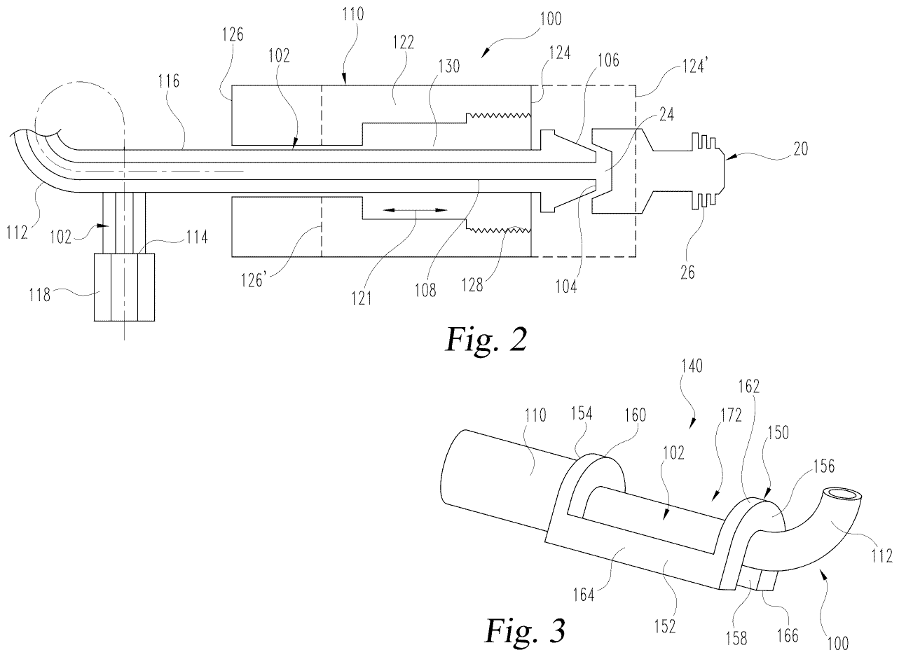

Referring further to FIG. 2, connector body 102 is elongated and extends from first end 104 to an opposite second end 114. In an embodiment, connector body 102 is in the form of a tube with a flow passage 108 to provide fuel flow from fuel rail 42 to fuel injector 22. Second end 114 may include a fitting 118 or other device that is engageable to a complementary fitting of second fuel system component 40. First end 104 may include end form 106 that is configured sealingly engage a complementary receptacle 24 of first fuel system component 20. In an embodiment, end form 106 is an outwardly flared portion at first end 104 of tubular-shaped connector body 102. However, other types of end forms 106 are also contemplated, including beads, flanges, flares, notches, swages, and combinations thereof.

Connector body 102 includes at least one bend 112 between first end 104 and second end 114. An end portion 116 of connector body 102 extends from bend 112 to first end 104. Fastener 110 is positioned around connector body 102 at end portion 116, and unless retained in position by apparatus 140, fastener 110 is movable along end portion 116 as indicated by arrows 121 from bend 112 to end form 106 before engagement of fastener 110 with first fuel system component 20.

Fastener 110 includes an elongated tubular body 122 with an internal bore 130 that receives connector body 102 therethrough such that tubular body 122 is positioned around connector body 102. Elongated tubular body 122 extends from an engagement end 124 to a driver end 126 opposite engagement end 124. In an embodiment, driver end 126 of fastener 110 is engageable by a driver tool such as a wrench, and engagement end 124 can include internal threads 128 that are engaged to external threads 26 on first fuel system component 20 by rotating driver end 126 with the wrench or other driver tool. In an embodiment, elongated tubular body 122 is configured like a tube nut with driver end 126 having external flats to engage the driving tool and engagement end 124 including internal threads that are separated longitudinally from the driver end 126 by elongated tubular body 122.

In an embodiment, first fuel system component 20 is located within an engine component, such as a valve cover 30 or another engine component. The location within valve cover 30 and/or seal 32 around fastener 110 may prevent the installer from being able to visualize first fuel system component 20 during engagement of fuel system connector 100. Since fastener 110 is not fixed in position along connector body 102, end form 106 may become exposed by being located outside of internal bore 130 and beyond engagement end 124 as shown in FIG. 2. As a result, end form 106 may be damaged as it is inserted into valve cover 30 since end form 106 may contact first fuel system component 20 or other structure in or of valve cover 30. A damaged end form 106 may not provide the desired sealing engagement with fuel system component 20.

Apparatus 140 is provided to maintain a position of fastener 110 along connector body 102 during assembly of a connector, such as fuel system connector 100, to a component, such as first fuel system component 20. Apparatus 140 maintains end form 106 within fastener 110, as shown in FIG. 1 and as indicated by the modified retained locations 124′, 126′ of engagement end 124 and driver end 126 in FIG. 2.

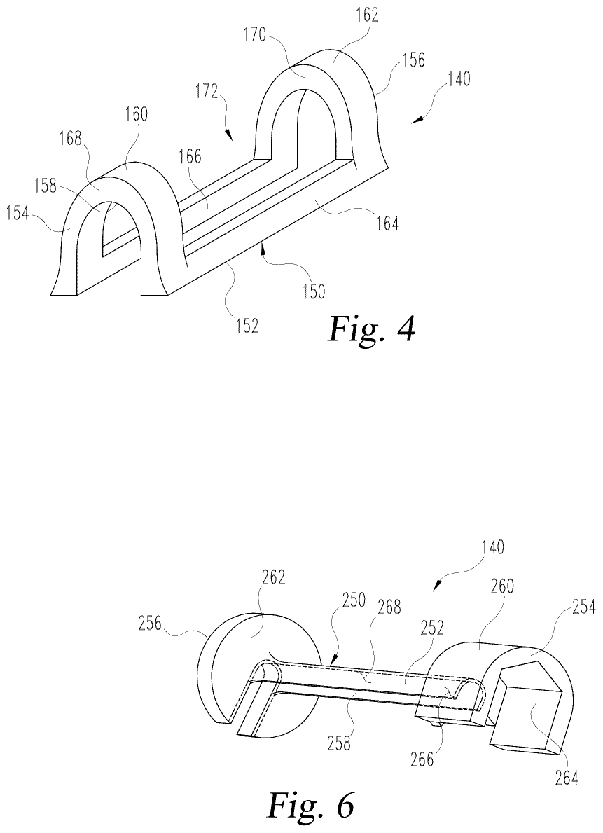

Referring to FIGS. 3-4, in an embodiment, apparatus 140 is in the form of a retainer 150 that is secured to connector body 102 in contact with fastener 110 and bend 112 to retain fastener 110 in a spaced relationship from bend 112. The length of retainer 150 ensures end form 106 is located within internal bore 130 of tubular body 122 as indicated by retained locations 124′, 126′ of fastener 110 and not positioned outside of engagement end 124. As a result, end form 106 is protected as connector body 102 and fastener 110 are inserted into position to engage component 20.

Retainer 150 includes spacer 152 extending between first end 154 and opposite second end 156. Spacer 152 also includes first end member 160 at first end 154 and second end member 162 at second end 156. Channel 158 extends from first end 154 to second end 156 along spacer 152, first end member 160, and second end member 162. Channel 158 is configured to receive connector body 102 of a connector, such as fuel system connector 100. First end member 160 is configured to contact fastener 110 of connector 100 at driver end 126. Second end member 162 is configured to contact connector body 102, such as at bend 112 or some other outwardly or laterally extending portion of connector body 102, and/or to grip connector body 102, to retain fastener 110 in position along connector body 102 in a manner that encapsulates end form 106 within fastener 110.

In an embodiment, channel 158 extends through first and second end members 160, 162 from first end 154 to second end 156. Spacer 152 includes a first spacer portion 164 along a first side of channel 158 that extends from first end member 160 to second end member 162. Spacer 152 includes a second spacer portion 166 along a second side of channel 158 that extends from first end member 160 to second end member 162.

In an embodiment of retainer 150, first end member 160 extends from first spacer portion 164 to second spacer portion 166 to form a first enclosed side 168 of channel 158. Similarly, second end member 162 extends from first spacer portion 164 to second spacer portion 166 to form a second enclosed side 170 of channel 158. Channel 158 includes an open side along first and second spacer portions 164, 166 and first and second end members 160, 162 that is opposite the first and second enclosed sides 168, 170 of channel 158.

End members 160, 162 allow spacer portions 164, 166 to be flexed away from one another about the enclosed sides 168, 170 to allow placement of retainer 150 on connector body 102 and removal of retainer 150 from connector body 102. Retainer 150 can be made from a plastic or other resilient material so that spacer portions 162, 164 elastically return toward one another after flexing away from one another to secure retainer 150 on connector body 102. However, materials which are non-elastic and/or that only allow a single use of retainer 150 are also contemplated.

In an embodiment of retainer 150, channel 158 includes an open side along spacer 152. The open side of channel 158 extends from first end 154 to second end 156 through first and second end member 160, 162. Spacer 152 defines a window 172 opposite the open side between first and second end members 160, 162. Window 172 provides material relief to facilitate insertion of retainer 150 on connector body 102, to maintain engagement to connector body 102, and facilitate removal after fastener 110 is provisionally engaged to component 20.

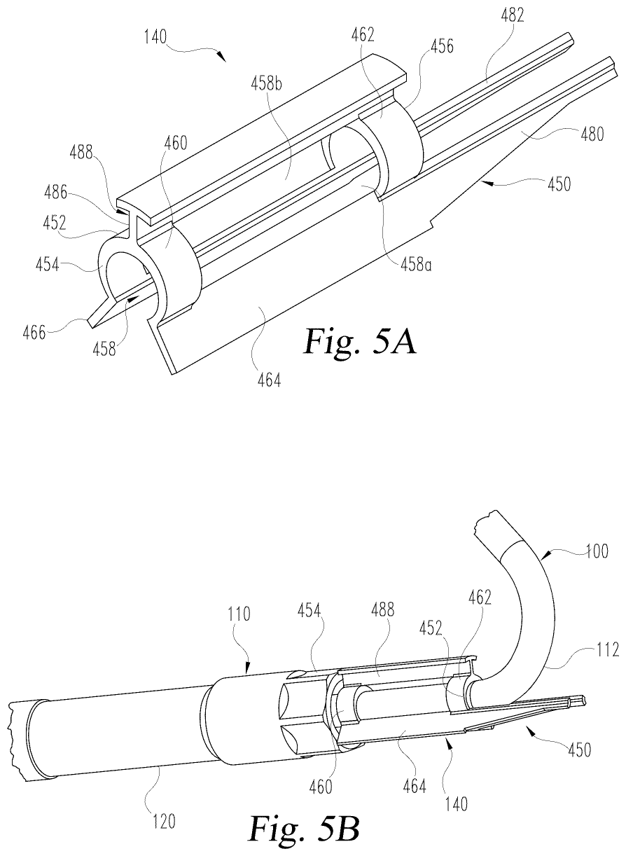

Referring to FIGS. 5A and 5B, another embodiment apparatus is shown and designated as retainer 450 that is able to be secured to connector body 102 in contact with fastener 110 and bend 112 to retain fastener 110 in a spaced relationship from bend 112 as discussed above for FIGS. 1-2. The length of retainer 450 ensures end form 106 is located within internal bore 130 of tubular body 122 as indicated by retained locations 124′, 126′ of fastener 110 and not positioned outside of engagement end 124. As a result, end form 106 is protected as connector body 102 and fastener 110 are inserted into position to engage component 20.

Retainer 450 includes spacer 452 extending between first end 454 and opposite second end 456. Spacer 452 also includes first end member 460 at first end 454 and second end member 462 at second end 456. First and second end members 460, 462 are formed connected to one another by and integrally formed with a rail 488 that extends along spacer 452.

Channel 458 extends from first end 454 to second end 456 along spacer 452, first end member 460, and second end member 462. Windows 458a, 458b between end members 460, 462 open into channel 458. Channel 458 is configured to receive connector body 102 of a connector, such as fuel system connector 100. First end member 460 is configured to contact fastener 110 of connector 100 at driver end 126.

In an embodiment, channel 458 extends through first and second end members 460, 462 from first end 454 to second end 456. Spacer 452 includes a first spacer portion 464 along a first side of channel 458 that extends from first end member 460 to second end member 462. Spacer 452 includes a second spacer portion 466 along a second side of channel 458 that extends from first end member 460 to second end member 462.

First and second extension members 480, 482 extend outwardly from respective ones of first spacer portion 464 and second spacer portion 466 and/or from second end member 462. Extension members 480, 482 provide a platform to grip retainer 450 and flex spacer portions 464, 466 away from one another to adjust, remove, and/or release retainer 450 from connector body 102. Extension members 480, 482 can project past or beyond bend 112 or some other outwardly or laterally extending portion of connector body 102 to facilitate access to retainer 450.

In an embodiment, rail 488 includes a base 486 that projects outwardly and away from each of first end member 460 and second end member 462. Rail 488 also includes a flange 484 projecting laterally outwardly from an outer end of base 486 to provide structural support for spacer 452. In an embodiment, rail 488 extends along and is connected to spacer 452 along all or a portion of a length of end members 460, 462. Base 486 extends outwardly from end members 460, 462 along a side of spacer 452 that is opposite the opening into channel 458 between first and second spacer portions 464, 466.

In an embodiment of retainer 450, first and second spacer portions 464, 466 extend along an open side of channel 458 that is opposite rail 488. First and second spacer portions 464, 466 are able to flex to facilitate placement of retainer 450 on connector body 102 and removal of retainer 450 from connector body 102. Retainer 450 can be made from a plastic or other resilient material so that first and second spacer portions 464, 466 elastically return toward one another after flexing away from one another to secure retainer 450 on connector body 102. However, materials which are non-elastic and/or that only allow a single use of retainer 450 are also contemplated.

Referring to FIG. 6, another embodiment of apparatus 140 is shown and designated as retainer 250. Retainer 250 functions similarly to retainer 150, but is employed as re-usable tool that is used to retain fastener 110 in a position along connector body 102 so that end form 106 is located within fastener 110 as fastener 110 is positioned into engagement with first fuel system component 20. The length of retainer 250 ensures end form 106 is located within internal bore 130 of tubular body 122 as indicated by retained locations 124′, 126′ of fastener 110 in FIG. 2 and not positioned outside of engagement end 124. As a result, end form 106 is protected as connector body 102 and fastener 110 are inserted into position to engage component 20.

Retainer 250 includes spacer 252 extending between first end 254 and opposite second end 256. Spacer 252 includes channel 258 extending from first end 254 to second end 256. Channel 258 is configured to receive connector body 102 of a connector, such as fuel system connector 100. Spacer 252 also includes first end member 260 at first end 254 and a second end member 262 at second end 256. First end member 260 is configured to contact fastener 110 of connector 100. Second end member 262 is configured to contact connector body 102, such as at bend 112 or other outwardly or laterally extending portion of connector body 102, or to grip connector body 102, to retain fastener 110 in position along connector body 102 when first end member 260 is in contact with fastener 110.

In an embodiment, retainer 250 includes an inner receptacle 264 in first end member 260. Inner receptacle 264 is configured to receive a portion of fastener 110 therein, such as driver end 126. For example, if driver end 126 includes external flats configured to be engaged by a wrench, inner receptacle 264 includes a complementary shape to interfit with driver end 126. In a specific embodiment, inner receptacle 264 is shaped to fit around a nut-shaped driver end 126. In an embodiment, an outer surface 266 of the first end member 260 is circular shaped so that it cannot be engaged by a wrench. This ensures retainer 250 can only be used to hand-tighten fastener 110 to provisionally engage it to component 20 while end form 106 is protected and maintained in a correct alignment with component 20. Retainer 250 is then removed from connector body 102 and fastener 110 is engaged by the driving tool to finally engage fastener 110 to component 20 and cause end form 106 to engage component 20 in the correct alignment.

In an embodiment, spacer 252 includes a cylindrical body 268 extending from first end member 260 to second end member 262. Channel 258 is formed along one side of cylindrical body 268 to allow retainer 250 to be side-loaded into connector body 102 between fastener 110 and bend 112. First end member 260 and second end member 262 each project outwardly from cylindrical body 268 to engage driver end 126 and bend 112, respectively.

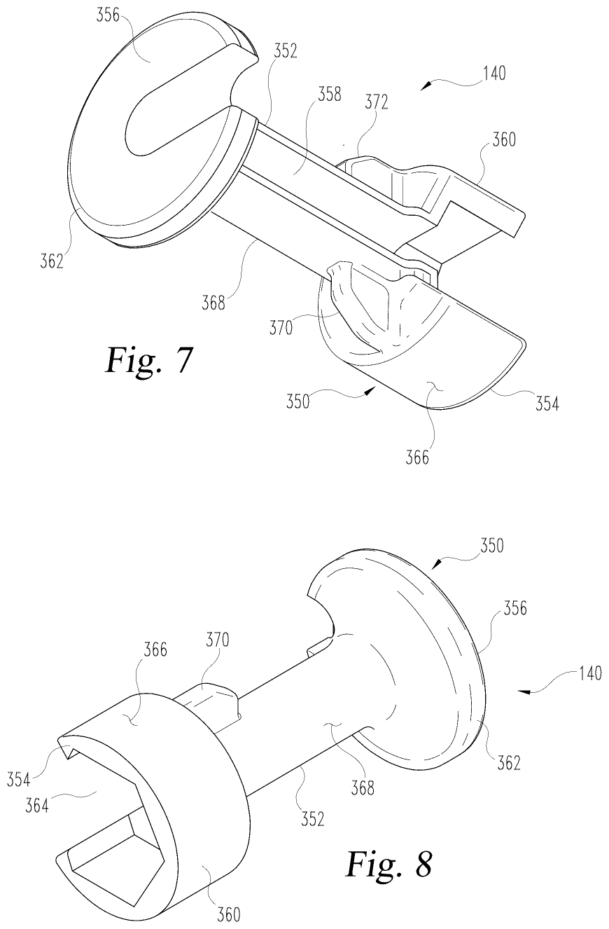

Referring to FIGS. 7-8, another embodiment of apparatus 140 is shown and designated as retainer 350. Retainer 350 functions similarly to retainer 250 and is employed as re-usable tool that is used to retain fastener 110 in a position along connector body 102 so that end form 106 is located within fastener 110 as fastener 110 is positioned into engagement with first fuel system component 20. The length of retainer 350 ensures end form 106 is located within internal bore 130 of tubular body 122 as indicated by retained locations 124′, 126′ of fastener 110 in FIG. 2 and not positioned outside of engagement end 124. As a result, end form 106 is protected as connector body 102 and fastener 110 are inserted into position to engage component 20.

Like retainer 250, retainer 350 includes spacer 252 extending between first end 354 and opposite second end 356. Spacer 352 includes channel 358 extending from first end 354 to second end 356. Channel 358 is configured to receive connector body 102 of a connector, such as fuel system connector 100. Spacer 352 also includes first end member 360 at first end 354 and a second end member 362 at second end 356. First end member 360 is configured to contact fastener 110 of connector 100. Second end member 362 is configured to contact connector body 102, such as at bend 112 or other outwardly or laterally extending portion of connector body 102, or to grip connector body 102, to retain fastener 110 in position along connector body 102 when first end member 360 is in contact with fastener 110.

In an embodiment, retainer 350 includes an inner receptacle 364 in first end member 360. Inner receptacle 364 is configured to receive a portion of fastener 110 therein, such as driver end 126. For example, if driver end 126 includes external flats configured to be engaged by a wrench, inner receptacle 364 includes a complementary shape to interfit with driver end 126. In a specific embodiment, inner receptacle 364 is shaped to fit around a nut-shaped driver end 126. In an embodiment, an outer surface 366 of the first end member 360 is circular shaped so that it cannot be engaged by a wrench. This ensures retainer 350 can only be used to hand-tighten fastener 110 to provisionally engage it to component 20 while end form 106 is protected and maintained in a correct alignment with component 20. Retainer 350 is then removed from connector body 102 and fastener 110 is engaged by the driving tool to finally engage fastener 110 to component 20 and cause end form 106 to engage component 20 in the correct alignment.

In an embodiment, spacer 352 includes a cylindrical body 368 extending from first end member 360 to second end member 362. Channel 358 is formed along one side of cylindrical body 238 to allow retainer 350 to be side-loaded into connector body 102 between fastener 110 and bend 112. First end member 360 and second end member 362 each project outwardly from cylindrical body 268 to engage driver end 126 and bend 112, respectively.

In addition, retainer 350 includes a first tab 370 and a second tab 372. First and second tabs 370, 372 extend between spacer 352 and first end member 360. First and second tabs 370, 372 project outwardly from opposite sides of cylindrical body 368 and span the space from an outer surface of cylindrical body 368 to outer surface 366 of first end member 360. First and second tabs 370, 372 assist the technician that uses retainer 350 to grip and/or manipulate retainer 350.

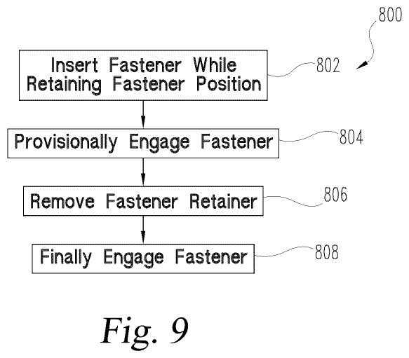

Referring to FIG. 9, a method 800 is provided for assembling fuel system connector 120 to fuel system component 20. Method 800 includes a step 802 of inserting fastener 110 into fuel system component 20 while retained with retainer 150, 250, 350, 450. Method 800 continues from step 802 at step 804 of provisionally engaging fastener 110 to fuel system component 20. After step 804, method 800 continues at step 806 of removing retainer 150, 250, 350, 450 from fuel system connector 100, and then continues at step 808 to finally engage fastener 110 to fuel system component 20.

In an embodiment, step 802 includes using retainer 150, 250, 350, 450 mounted to connector body 102 to maintain a position of fastener 110 along connector body 102 so that end form 106 of connector body 102 is retained within fastener 110 during installation. Retainer 150, 250, 350, 450 is removed from connector body 102 after provisionally engaging fastener 110 to fuel system component 20 since end form 106 is now aligned with fuel system component 20 by the provisional engagement of fastener 110. The final engagement of fastener 110 to fuel system component 20 places the aligned end form 106 into engagement with fuel system component 20.

In an embodiment, the retainer 150, 250, 350, 450 of method 800 is retainer 150, 450 as disclosed above. Retainer 150, 450 is installed on connector body 102 during assembly of fastener 110 and connector body 102. The fuel system connector 100 with the pre-mounted retainer 150, 450 is shipped, packaged, or otherwise provided to the installer and protects end form 106 within fastener 110 even before installation. Retainer 150, 450 is removed after provisionally engaging fastener 110 to fuel system component 20 and discarded.

In an embodiment, the retainer 150, 250, 350, 450 of method 800 is retainer 250, 350 as disclosed above. Retainer 250, 350 is a tool that is placed on connector body 102 and engaged to fastener 110 by the installer before inserting fastener 110 and provisionally engaging it to fuel system component 20. Retainer 250, 350 is then removed after provisional engagement of fastener 110 to the fuel system component, and may be re-used for provisionally engaging the next fuel system connector 100 to the fuel system component 20.

In an embodiment of method 800, fuel system component 20 is fuel injector 22 located within valve cover 24. In an embodiment of method 800, connector body 102 of fuel system connector 100 is an injector tube with at least one bend 112, and fastener 110 of fuel system connector 102 is an elongated tube nut positioned around the injector tube. Retainer 150, 250, 350 extends between and contacts fastener 110 and the at least one bend 112 to retain fastener 110 in a position that encapsulates end form 106.

While the present application includes description and claims directed to fuel system components, aspects of the present disclosure may be applicable for other applications. For example, non-fuel system applications are contemplated in which it is desired to maintain an end form on an elongated connector body within the fastener of the connector during assembly.

According to one aspect of the present disclosure, a system for assembling fuel system components is provided. The system includes a fuel system connector that connects a first fuel system component and a second fuel system component to one another. The fuel system connector includes a connector body configured to extend from the first fuel system component toward the second fuel system component. The connector body includes a first end having an end form for connection to the first fuel system component. The fuel system connector also includes a fastener positioned around and movable along the connector body toward and away from the first end of the connector body. The fastener is engageable to the first fuel system component to secure the end form in connection with the first fuel system component. The system also includes a retainer removably mounted to the connector body in contact with the fastener. The retainer secures the fastener in a position along the connector body so that the end form is located within the fastener as the fastener is positioned on the first fuel system component.

In an embodiment, the connector body is a tube and the end form on the first end includes an outwardly flared portion of the tube.

In an embodiment, the fastener includes an elongated tubular body positioned around the connector body. The elongated tubular body extends from an engagement end of the tubular body to a driver end of the tubular body. The driver end is engageable by a driver tool to rotate the fastener around the connector body to engage the engagement end to the first fuel system component.

In an embodiment, the engagement end includes internal threads for threadingly engaging the fuel system component, and the driver end includes a nut engageable by the driver tool.

In an embodiment, the first fuel system component is a fuel injector, the second fuel system component is a fuel rail, and the fuel system connector includes an injector tube with a passage for providing fuel flow from the fuel rail to the fuel injector.

In an embodiment, the retainer includes a first end member that contacts the fastener and a second end member spaced from the first end member. The second end member is configured to engage the connector body to maintain the retainer in position along the connector body. A spacer extends between the first end member and the second end member.

In an embodiment, the retainer includes a channel that extends along the first end member, the spacer, and the second end member. The channel is configured to receive the connector body therein when the retainer is removably mounted to the connector body.

In an embodiment, the first end member includes a receptacle configured to receive a driver end of the fastener therein.

In an embodiment, the connector body includes a bend. The second end member of the retainer contacts the bend to maintain the retainer in position along the connector body.

In an embodiment, retainer includes a pair of extension members extending from the second end member past the bend.

According to another aspect of the present disclosure, an apparatus for assembling fuel system components is provided. The apparatus includes a spacer extending between a first end and an opposite second end, a first end member at the first end, and a second end member at the second end. The first end member is configured to contact a fastener of the connector and the second end member configured to contact a connector body of the connector. The apparatus includes a channel extending along the spacer, the first end member, and the second end member. The channel is configured to receive the connector body to secure the apparatus to the connector body and retain the fastener in a position along the connector body with the first end member contacting the fastener and the second end member contacting the connector body.

In an embodiment, the channel extends through the first and second end members from the first end to the second end. The spacer includes a first spacer portion along a first side of the channel that extends from the first end member to the second end member. The spacer includes a second spacer portion along a second side of the channel that extends from the first end member to the second end member.

In an embodiment, the first end member extends from the first spacer portion to the second spacer portion to form a first enclosed side of the channel. The second end member extends from the first spacer portion to the second spacer portion to form a second enclosed side of the channel. The channel includes an open side along the first and second spacer portions and the first and second end members, the open side opposite the first and second enclosed sides of the channel.

In an embodiment, the channel includes an open side along the spacer. The open side of the channel extends from the first end to the second end through the first and second end members. The spacer defines a window opposite the open side between the first and second end members.

In an embodiment, the first end member includes an inner receptacle configured to receive a portion of the fastener therein.

In an embodiment, the inner receptacle is shaped to fit around a nut. The outer surface of the end member is circular shaped.

In an embodiment, at least one tab extends between the spacer and the first end member. The at least one tab projects outwardly from the spacer.

In an embodiment, the spacer includes a cylindrical body extending from the first end member to the second end member. The channel is formed along one side of the cylindrical body, the first end member, and the second end member. The first end member and the second end member each project outwardly from the cylindrical body.

In an embodiment, first and second extension members extend outwardly from the second end member.

According to another aspect of the present disclosure, a method for assembling fuel system components is provided. The method includes inserting a fastener of the fuel system connector into the fuel system component while maintaining a position of the fastener along a connector body of the fuel system connector with a retainer removably mounted to the connector body in contact with the fastener so that an end form on an end of the connector body remains located within the fastener; provisionally engaging the fastener to the fuel system component while the retainer is mounted to the connector body to maintain the end form of the connector body within the fastener; removing the retainer from the connector body after provisionally engaging the fastener to the fuel system component; and finally engaging the fastener to the fuel system component so that the end form engages the fuel system component.

In an embodiment, the retainer is discarded after removing the retainer. In another embodiment, the retainer is a tool that is re-used.

In embodiment, the fuel system component is a fuel injector located within a valve cover. The connector body of the fuel system connector is an injector tube with at least one bend. The fastener of the fuel system connector is an elongated nut positioned around the injector tube. The retainer extends between and contacts the fastener and the at least one bend.

While illustrative embodiments of the disclosure have been illustrated and described in detail in the drawings and foregoing description, the same is to be considered as illustrative and not restrictive in character, it being understood that only certain exemplary embodiments have been shown and described and that all changes and modifications that come within the spirit of the claimed inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Non-limiting examples of what may be claimed in one or more non-provisional applications claiming priority to the present application include the following.

What is claimed is:

1. A system for assembling fuel system components, the system comprising:
a fuel system connector that connects a first fuel system component and a second fuel system component to one another, the fuel system connector including:
a connector body configured to extend from the first fuel system component toward the second fuel system component, the connector body including a first end having an end form for connection to the first fuel system component; and
a fastener positioned around and movable along the connector body toward and away from the first end of the connector body, the fastener engageable to the first fuel system component to secure the end form in connection with the first fuel system component; and
a retainer removably mounted to the connector body in contact with the fastener, the retainer securing the fastener in a position along the connector body so that the end form is located within the fastener as the fastener is positioned on the first fuel system component.

2. The system of claim 1, wherein:
the connector body is a tube; and
the end form on the first end includes an outwardly flared portion of the tube.

3. The system of claim 1, wherein the fastener includes an elongated tubular body positioned around the connector body, the elongated tubular body extending from an engagement end of the tubular body to a driver end of the tubular body, the driver end engageable by a driver tool to rotate the fastener around the connector body to engage the engagement end to the first fuel system component.

4. The system of claim 3, wherein:
the engagement end includes internal threads for threadingly engaging the fuel system component; and
the driver end includes a nut engageable by the driver tool.

5. The system of claim 1, wherein:
the first fuel system component is a fuel injector;
the second fuel system component is a fuel rail; and
the fuel system connector includes an injector tube with a passage for providing fuel flow from the fuel rail to the fuel injector.

6. The system of claim 1, wherein the retainer includes:
a first end member that contacts the fastener;
a second end member spaced from the first end member, the second end member configured to engage the connector body to maintain the retainer in position along the connector body; and
a spacer between the first end member and the second end member.

7. The system of claim 6, wherein the retainer includes a channel that extends along the first end member, the spacer, and the second end member, the channel configured to receive the connector body therein when the retainer is removably mounted to the connector body.

8. The system of claim 6, wherein the first end member includes a receptacle configured to receive a driver end of the fastener therein.

9. The system of claim 6, wherein:
the connector body includes a bend; and
the second end member of the retainer contacts the bend to maintain the retainer in position along the connector body.

10. The system of claim 6, wherein the retainer includes a pair of extension members extending outwardly from the second end member past the bend.

11. An apparatus for assembling a connector to a component, the apparatus comprising:
a spacer extending between a first end and an opposite second end;
a first end member at the first end, the first end member configured to contact a fastener of the connector;
a second end member at the second end, the second end member configured to contact a connector body of the connector; and
a channel extending along the spacer, the first end member, and the second end member, the channel configured to receive the connector body of the connector to secure the apparatus to the connector body and retain the fastener in a position along the connector body with the first end member contacting the fastener and the second end member contacting the connector body.

12. The apparatus of claim 11, wherein:
the channel extends through the first and second end members from the first end to the second end;
the spacer includes a first spacer portion along a first side of the channel that extends from the first end member to the second end member; and
the spacer includes a second spacer portion along a second side of the channel that extends from the first end member to the second end member.

13. The apparatus of claim 12, wherein:
the first end member extends from the first spacer portion to the second spacer portion to form a first enclosed side of the channel;
the second end member extends from the first spacer portion to the second spacer portion to form a second enclosed side of the channel; and
the channel includes an open side along the first and second spacer portions and the first and second end members, the open side opposite the first and second enclosed sides of the channel.

14. The apparatus of claim 11, wherein:
the channel includes an open side along the spacer, the open side of the channel extending from the first end to the second end through the first and second end members; and
the spacer defines a window opposite the open side between the first and second end members.

15. The apparatus of claim 11, wherein the first end member includes an inner receptacle configured to receive a portion of the fastener therein.

16. The apparatus of claim 15, wherein:
the inner receptacle is shaped to fit around a nut; and
an outer surface of the end member is circular shaped.

17. The apparatus of claim 15, further comprising at least one tab extending between the spacer and the first end member, the at least one tab projecting outwardly from the spacer.

18. The apparatus of claim 11, wherein:
the spacer includes a cylindrical body extending from the first end member to the second end member;
the channel is formed along one side of the cylindrical body, the first end member, and the second end member; and
the first end member and the second end member each project outwardly from the cylindrical body.

19. The apparatus of claim 11, wherein the second end member includes first and second extension members extending outwardly therefrom.

20. A method for assembling a fuel system connector to a fuel system component, the method comprising:
inserting a fastener of the fuel system connector into the fuel system component while maintaining a position of the fastener along a connector body of the fuel system connector with a retainer removably mounted to the connector body in contact with the fastener so that an end form on an end of the connector body remains located within the fastener;
provisionally engaging the fastener to the fuel system component while the retainer is mounted to the connector body to maintain the end form of the connector body within the fastener;
removing the retainer from the connector body after provisionally engaging the fastener to the fuel system component; and
finally engaging the fastener to the fuel system component so that the end form engages the fuel system component.

21. The method of claim 20, further comprising discarding the retainer after removing the retainer.

22. The method of claim 20, further comprising re-using the retainer as a tool to insert and provisionally engage a second fastener to a second fuel system component.

23. The method of claim 20, wherein:
inserting the fastener includes inserting the fastener into a valve cover to engage a fuel injector located within the valve cover, and the connector body of the fuel system connector is an injector tube with at least one bend, the fastener of the fuel system connector is an elongated nut positioned around the injector tube, and the retainer extends between and contacts the fastener and the at least one bend.
